(19) United States
(12) Patent Application Publication
(10) Pub. No.: US 2016/0216553 A1
(43) Pub. Date: Jul. 28, 2016

(54) LIQUID-CRYSTAL DISPLAY APPARATUS AND HEAD-UP DISPLAY

(71) Applicant: ORTUS TECHNOLOGY CO., LTD., Hino (JP)

(72) Inventor: Tomohiko OTANI, Hino (JP)

(73) Assignee: ORTUS TECHNOLOGY CO., LTD., Hino (JP)

(21) Appl. No.: 15/092,277

(22) Filed: Apr. 6, 2016

Related U.S. Application Data
(63) Continuation of application No. PCT/JP2014/077722, filed on Oct. 17, 2014.

(30) Foreign Application Priority Data
Oct. 18, 2013 (JP) 2013-217897

(51) Int. Cl. G02F 1/1335; G02B 27/01; G02F 1/1368

(52) U.S. Cl. CPC G02F 1/133512; G02F 1/1368; G02F 1/133514; G02F 1/133553; G02B 27/0101; G02B 2027/012; G02B 2027/0112

(57) ABSTRACT

A liquid-crystal display apparatus includes a first substrate arranged opposite to a light source; a second substrate arranged opposite to the first substrate; a liquid-crystal layer sandwiched between the first substrate and the second substrate; a color filter provided on the first substrate and having coloring members provided in association with pixels; a black matrix provided on the first substrate and between adjacent coloring members; and switching transistors provided on the second substrate in association with the pixels. The black matrix is shifted with respect to the center of a switching transistor.

### CROSS-REFERENCE TO RELATED APPLICATIONS

This application is a Continuation Application of PCT Application No. PCT/JP2014/077722, filed Oct. 17, 2014, and based upon and claiming the benefit of priority from Japanese Patent Application No. 2013-217897, filed Oct. 18, 2013, the entire contents of all of which are incorporated herein by reference.

### BACKGROUND OF THE INVENTION

1. Field of the Invention

The present invention relates to a liquid-crystal display apparatus and a head-up display.

2. Description of the Related Art

A head-up display (HUD) is known which projects (radiates) display light from a display on a windshield (projection member) of a vehicle to display a virtual image (display image). This head-up display irradiates the windshield of the vehicle with an image displayed by a display apparatus and indicating a vehicle speed and the like, to superimpose the image on a forward visual field of a driver or on scenery in the vicinity of the forward visual field. Consequently, the driver can read information substantially without moving his or her visual field in a driving state.

In the in-vehicle head-up display, due to the structure thereof, external light such as sunlight may be radiated to the display apparatus adopted for the head-up display. In this case, an unwanted image not to be displayed is projected on the windshield, degrading display quality of the display image viewed by the driver. To avoid this, for example, the display apparatus is designed to be arranged at a predetermined tilt angle to a normal direction of an optical path of the light source.

However, this angle may act to make light from the light source likely to enter switching transistors (TFTs). When an active layer in each of the TFTs is irradiated with light, an off characteristic of the TFT is degraded. Furthermore, a part of each pixel which otherwise transmits light is shielded from light by a black matrix, leading to a reduced transmittance of the display apparatus.

### BRIEF SUMMARY OF THE INVENTION

According to an aspect of the present invention, there is provided a liquid-crystal display apparatus in which a perpendicular of a display surface of the liquid-crystal display apparatus is inclined through a tilt angle to an optical path of a light source, comprising:

a first substrate arranged opposite to the light source;

a second substrate arranged opposite to the first substrate;

a liquid-crystal layer sandwiched between the first substrate and the second substrate;

a color filter provided on the first substrate and having coloring members provided in association with pixels;

a black matrix provided on the first substrate and between adjacent coloring members; and

switching transistors provided on the second substrate in association with the pixels,

wherein the following expression is satisfied:

$$Δ = d \cdot \frac{sin θ}{\sqrt{{n}^{2} - {sin}^{2} θ}}$$

where the tilt angle is denoted by θ, a distance between the first substrate and the second substrate is denoted by d, a refractive index of each of the first and second substrates is denoted by n, and a shift amount by which the black matrix is shifted with respect to a center of a switching transistor is denoted by Δ.

According to an aspect of the present invention, there is provided a liquid-crystal display apparatus in which a perpendicular of a display surface of the liquid-crystal display apparatus is inclined through a tilt angle to an optical path of a light source, comprising:

a first substrate arranged opposite to the light source;

a second substrate arranged opposite to the first substrate;

a liquid-crystal layer sandwiched between the first substrate and the second substrate;

switching transistors provided on the first substrate in association with pixels;

a color filter provided on the second substrate and having coloring members provided in association with the pixels; and

a black matrix provided on the second substrate and between adjacent coloring members,

wherein the following expression is satisfied:

$$Δ = d \cdot \frac{sin θ}{\sqrt{{n}^{2} - {sin}^{2} θ}}$$

where the tilt angle is denoted by θ, a distance between the first substrate and the second substrate is denoted by d, a refractive index of each of the first and second substrates is denoted by n, and a shift amount by which the black matrix is shifted with respect to a center of a switching transistor is denoted by Δ.

According to an aspect of the present invention, there is provided a head-up display comprising:

a light source;

the liquid-crystal display apparatus according to one of the above aspects, the liquid-crystal display apparatus transmitting light from the light source; and

a reflection member which reflects display light from the liquid-crystal display apparatus toward a screen.

### BRIEF DESCRIPTION OF THE SEVERAL VIEWS OF THE DRAWINGS

FIG. 1 is a sectional view of a head-up display according to a first embodiment;

FIG. 2 is a sectional view of a liquid-crystal display apparatus according to the first embodiment;

FIG. 3 is a sectional view of a liquid-crystal display apparatus according to a comparative example;

FIG. 4 is a diagram illustrating light shielding areas defined by a black matrix according to the comparative example;

FIG. 5 is a diagram illustrating light shielding areas defined by a black matrix according to the first embodiment;

FIG. 6 is an enlarged diagram of a part of the light shielding areas defined by the black matrix in FIG. 5;

FIG. 7 is a diagram of an example of a shift amount for the black matrix;

FIG. 8 is a schematic diagram of a liquid-crystal display apparatus according to a second embodiment; and

FIG. 9 is an enlarged diagram of a part of shielding areas defined by gate electrodes and a black matrix.

### DETAILED DESCRIPTION OF THE INVENTION

The embodiments of the present invention will be described below with reference to the accompanying drawings. Note that the drawings are schematic and conceptual, and the dimensions, ratios, and the like in the respective drawings are not necessary the same as those in reality. In addition, even the same portion may be shown in a different dimensional relationship or with different ratios in different drawings. Several embodiments to be described below represent examples of apparatuses and methods for embodying the technical idea of the present invention, and the technical idea of the present invention is not specified by the shapes, structures, and layouts of the constituent parts. The technical idea of the present invention can be embodied by modifying constituent elements without departing from the gist of the invention. Note that in the following explanation, the same reference numerals denote elements having the same functions and arrangements, and a repetitive explanation will be made only when necessary.

### First Embodiment

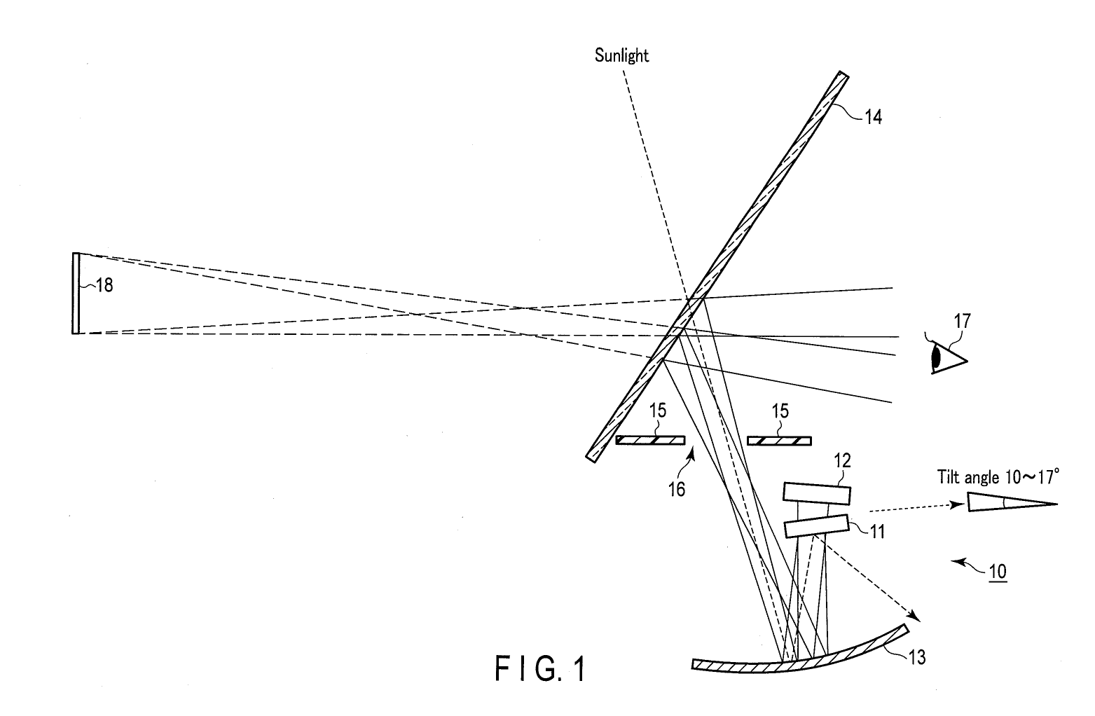

FIG. 1 is a sectional view of a head-up display 10 according to a first embodiment. The head-up display 10 is housed inside a dashboard (instrument panel) 15 in a vehicle. The head-up display 10 comprises a liquid-crystal display apparatus 11, a light source 12, and a reflection member 13.

The light source 12 is, for example, a light emitting diode (LED) and supplies illumination light to the liquid-crystal display apparatus 11. The liquid-crystal display apparatus 11 transmits the illumination light from the light source 12 and displays images indicative of driving information such as a vehicle speed.

The reflection member 13 is, for example, a concave mirror. The concave mirror 13 reflects display light from the liquid-crystal display apparatus 11 toward a screen (displayed member) 14. The screen 14 is, for example, a windshield of a vehicle (car). Furthermore, the concave mirror 13 magnifies the display light from the liquid-crystal display apparatus 11 at a predetermined magnification percentage. The display light emitted from the liquid-crystal display apparatus 11 is reflected by the concave mirror 13 and passes through an opening portion 16 formed in the dashboard (instrument panel) 15 in the vehicle. The display light is then radiated to the windshield 14 of the vehicle. A driver 17 views a virtual image (display image) 18 resulting from irradiation of the windshield 14 with the display light. Consequently, the driver 17 can observe the virtual image V displayed in front of his or her seat such that the virtual image V overlaps scenery.

A display surface of the liquid-crystal display apparatus 11 is inclined at a predetermined angle to a surface of the light source 12 (the surface through which the irradiation light is emitted). That is, the display surface has a predetermined tilt angle to the surface of the light source 12. In other words, the liquid-crystal display apparatus 11 is inclined to the light source 12 such that a perpendicular of the display surface (substrate surface) of the liquid-crystal display apparatus 11 has the predetermined tilt angle to an optical path of the light source 12. The reason for this is as follows.

Part of external light such as sunlight (hereinafter referred to as external light) passes through the windshield 14 and is reflected by the concave mirror 13 and radiated to the liquid-crystal display apparatus 11. At this time, if the display surface of the liquid-crystal display apparatus 11 is parallel to the surface of the light source 12, reflected light reflected by the liquid-crystal display apparatus 11 follows an optical path opposite to an optical path of the external light and is projected on the windshield 14. This results in an unwanted image that is otherwise not to be displayed, degrading display quality of display images viewed by the driver. Thus, as depicted in FIG. 1, the liquid-crystal display apparatus 11 and the light source 12 are arranged so as to have a tilt angle between the liquid-crystal display apparatus 11 and the light source 12. Then, reflected light resulting from reflection of the external light by the liquid-crystal display apparatus 11 is prevented from being reflected toward the concave mirror 13 as illustrated by an optical path depicted by a dashed line in FIG. 1. This enables degradation of display quality caused by reflected light from the liquid-crystal display apparatus 11 to be suppressed. The magnitude of the tilt angle varies depending on the size of the opening portion 16, a distance between the opening portion 16 and the concave mirror 13, a magnification percentage of the concave mirror 13, and the like. In the present embodiment, the tilt angle is, for example, 10° or more and 17° or less.

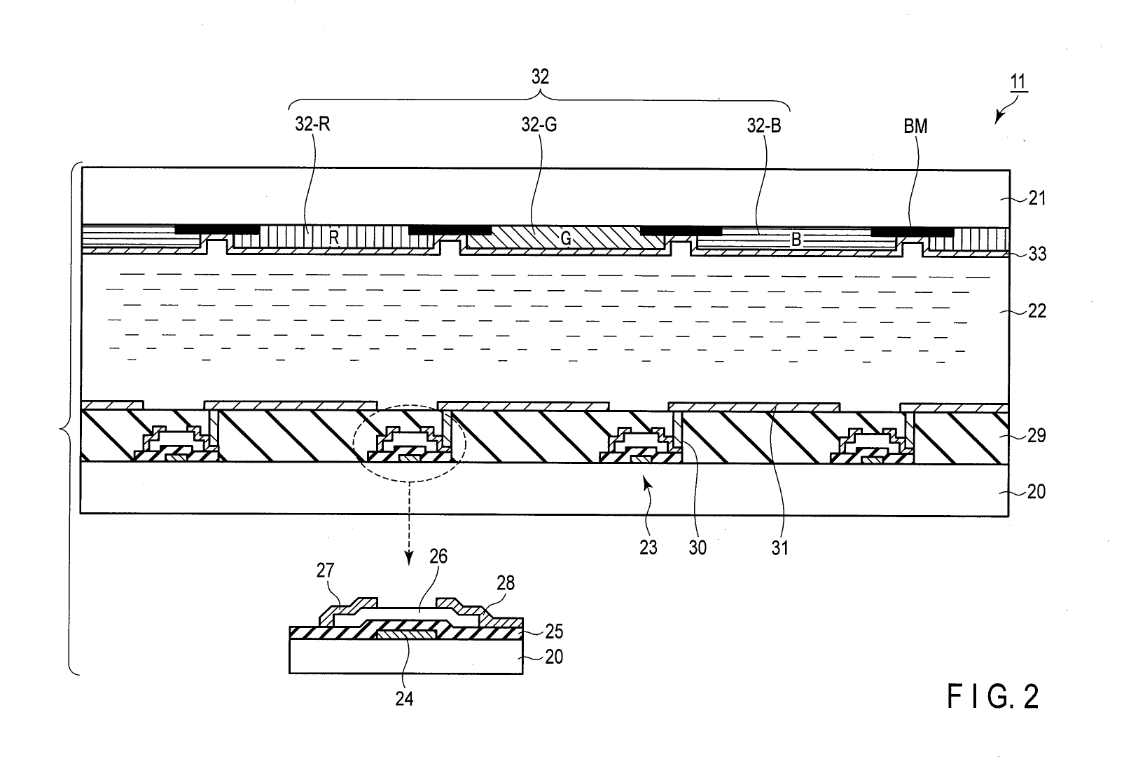

FIG. 2 is a sectional view of the liquid-crystal display apparatus 11 according to the first embodiment. The liquid-crystal display apparatus 11 comprises a TFT substrate 20 on which switching transistors, pixel electrodes, and the like are formed, a color filter substrate (CF substrate) 21 on which a color filter and a common electrode are formed and which is arranged opposite to the TFT substrate 20, and a liquid-crystal layer 22 sandwiched between the TFT substrate 20 and the CF substrate 21. The TFT substrate 20 and the CF substrate 21 are each formed of a transparent substrate (for example, a glass substrate). The CF substrate 21 is arranged opposite to the light source 12, and illumination light from the light source 12 enters the liquid-crystal display apparatus 11 through the CF substrate 21. A surface of the TFT substrate 20 which is opposite to the light source 12 is the display surface of the liquid-crystal display apparatus 11. In FIG. 2, illustration of a polarizing plate is omitted.

The liquid-crystal layer 22 is formed of a liquid-crystal material sealed between the TFT substrate 20 and the CF substrate 21 using a seal material (not depicted in the drawings) that bonds the TFT substrate 20 and the CF substrate 21 together. The liquid-crystal material has optical characteristics changed via controlling the orientation of liquid-crystal molecules in accordance with an electric field applied between the TFT substrate 20 and the CF substrate 21.

A plurality of switching transistors 23 are provided on a side of the TFT substrate 20 which faces the liquid-crystal layer 22. For example, thin film transistors (TFTs) are used as the switching transistors 23. Each of the switching transistors 23 comprises a gate electrode 24 electrically connected to a scan line (not depicted in the drawings), a gate insulating film 25 provided on the gate electrode 24, a semiconductor layer (for example, amorphous silicon) 26 provided on the gate insulating film 25, and a source electrode 27 and a drain electrode 28 provided on the semiconductor layer 26 so as to be spaced from each other. The source electrode 27 is electrically connected to a signal line (not depicted in the drawings). Although not depicted in the drawings, ohmic films formed of, for example, amorphous silicon into which n-type impurities are introduced are provided between the semiconductor layer 26 and the source electrode 27 and between the semiconductor layer 26 and the drain electrode 28.

An insulating layer 29 is provided on the switching transistors 23. A plurality of pixel electrodes 31 are provided on the insulating layer 29. Contact plugs 30 electrically connected to the pixel electrodes 31 are provided in the insulating layer 29 and on the drain electrodes 28.

A color filter 32 is provided on a side of the CF substrate 21 which faces the liquid-crystal layer 22. The color filter 32 comprises a plurality of coloring filters (coloring members), specifically, a plurality of red filters 32-R, a plurality of green filters 32-G, and a plurality of blue filters 32-B. General color filters comprise red (R), green (G), and blue (B), which are three primary colors of light. A set of adjacent three colors R, G, and B forms a display unit (referred to as a pixel). A single color portion R, G, or B of one pixel is a minimum driving unit and is referred to as a subpixel. The switching transistor 23 and the pixel electrode 31 are provided for each subpixel.

A light shielding black matrix (light shielding film) BM is provided at boundaries between the red filter 32-R and the green filter 32-G and the blue filter 32-B. That is, the black matrix BM is formed like a net. The black matrix BM has a function to shield, from light, a light shielding target pattern including the interconnections and switching transistors 23 provided on the TFT substrate 20. A portion of the black matrix BM which corresponds to one switching transistor 23 has a width set equal to or larger than the width of the switching transistor 23.

A common electrode 33 is provided on the color filter 32 and the black matrix BM. The common electrode 33 is formed all over a display area of the liquid-crystal display apparatus 11.

The pixel electrodes 31, the contact plugs 30, and the common electrode 33 are each formed of a transparent electrode. For example, ITO (Indium Tin Oxide) is used for the pixel electrodes 31, the contact plugs 30, and the common electrode 33. As the insulating layer 29, a transparent insulating material, for example, silicon nitride (SiN), is used.

Here, in the present embodiment, with the above-described tilt angle taken into account, the black matrix BM provided on the CF substrate 21 irradiated with the illumination light from the light source 12 is arranged to be shifted in a lateral direction so as to achieve optimum light shielding.

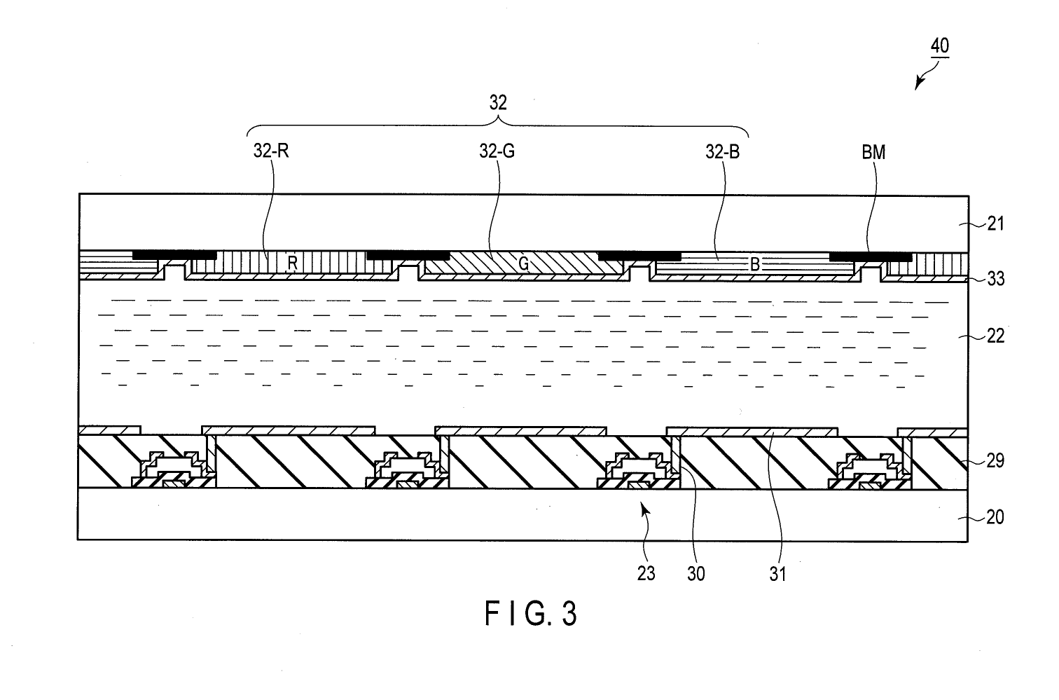

FIG. 3 is a sectional view of a liquid-crystal display apparatus 40 according to a comparative example. In the comparative example, the switching transistors 23 are arranged immediately below the black matrix BM. The liquid-crystal display apparatus 40 according to the comparative example has the same configuration as that of the liquid-crystal display apparatus 11 in FIG. 2 except for a positional relation between the black matrix BM and the switching transistors 23.

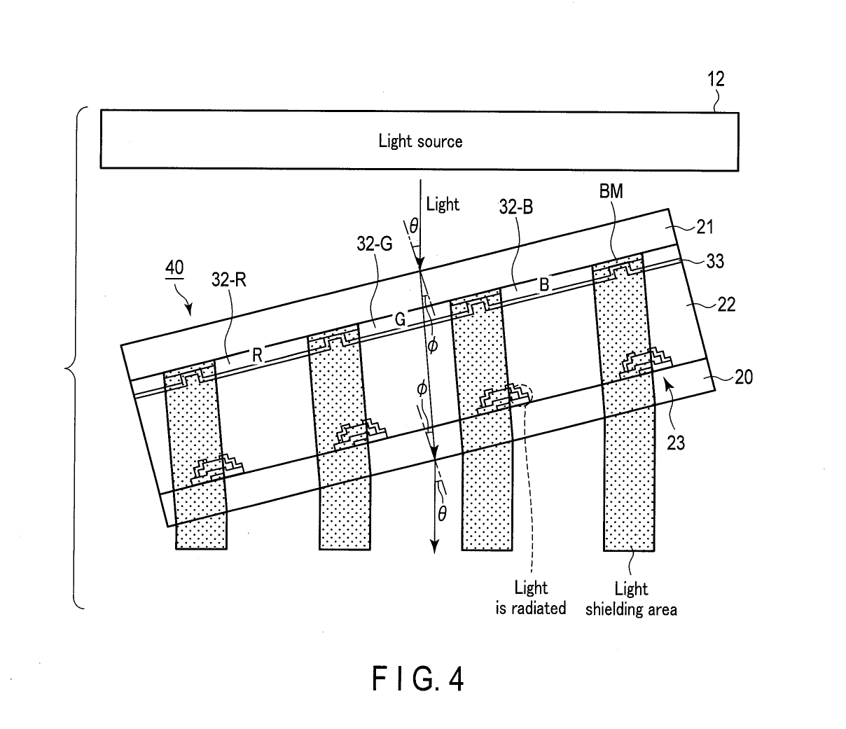

FIG. 4 is a diagram illustrating light shielding areas defined by the black matrix BM according to the comparative example. As described above, the display surface of the liquid-crystal display apparatus 11 is arranged to have a predetermined tilt angle with respect to the surface of the light source 12 (the surface through which the illumination light is emitted). The light source 12 irradiates the liquid-crystal display apparatus 11 with the illumination light. The black matrix BM partly shields the illumination light from the light source 12. In FIG. 4, the light shielding areas defined by the black matrix BM are hatched.

When the liquid-crystal display apparatus 11 and the light source 12 are arranged so as to have the predetermined tilt angle as depicted in FIG. 4, the black matrix BM fails to entirely shield each of the switching transistors 23 from light. A part of the switching transistor 23 is irradiated with light. Consequently, the off characteristics of the switching transistors 23 are degraded. Furthermore, the black matrix BM partly shields apertures of the pixels to reduce the transmittance for light transmitted by the liquid-crystal display apparatus 11. The aperture of the pixel is an area where an aperture in the black matrix BM overlaps, in a plan view, the aperture of the pixel corresponding to the entire pixel except for a light shielding target area to be shielded from light by the black matrix BM. The aperture of the pixel is a substantial display area.

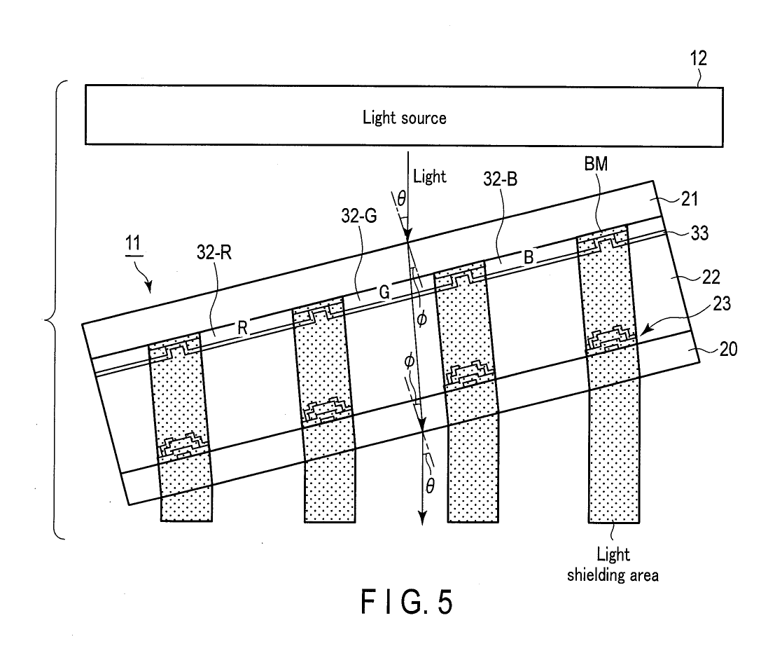

FIG. 5 is a diagram illustrating the light shielding areas defined by the black matrix BM according to the first embodiment. As described above, in the present embodiment, with the above-described tilt angle taken into account, the black matrix BM provided on the CF substrate 21 irradiated with the illumination light from the light source 12 is arranged to be shifted (arranged offset) in the lateral direction so as to achieve optimum light shielding. Consequently, each of the switching transistors 23 is substantially entirely shielded from light by the black matrix BM. This allows the off characteristics of the switching transistors 23 to be restrained from being degraded. Furthermore, the apertures (display areas) of the pixels are not substantially shielded from light by the black matrix BM, and thus, a reduction in transmittance can be suppressed.

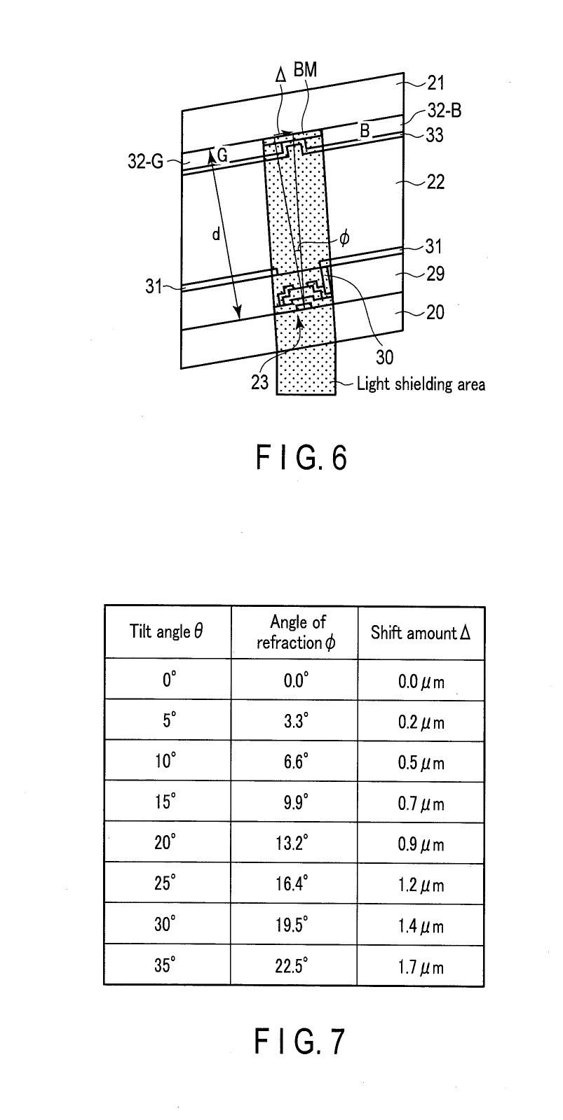

FIG. 6 is an enlarged diagram of a part of the light shielding areas defined by the black matrix BM in FIG. 5. The illumination light from the light source 12 is refracted upon entering the substrate 21, and furthermore, light having been transmitted by the liquid-crystal layer 22 is refracted upon being emitted from the substrate 20. Air has a refractive index of approximately 1. For example, the TFT substrate 20 and the CF substrate 21, both of which are formed of glass, have a refractive index of approximately 1.5. The color filter 32 and the liquid-crystal layer 22 have a refractive index of approximately 1.5, which is approximately the same as the refractive index of the TFT substrate 20 and the CF substrate 21. Hence, light transmitted through the liquid-crystal display apparatus 11 is considered to be substantially unrefracted, and the refraction of light transmitted through the liquid-crystal display apparatus 11 is not taken into account.

When the tilt angle between the display surface of the liquid-crystal display apparatus 11 and the surface of the light source 12 (that is, the incident angle of the illumination light from the light source 12) is denoted by θ, the angle of refraction of the liquid-crystal display apparatus 11 (that is, the refractive angle of the CF substrate 21) is denoted by φ, the angles of refraction of the TFT substrate 20, the CF substrate 21, the color filter 32, and the liquid-crystal layer 22 are all denoted by n, the following relation holds true based on Snell's law.

sin θ=n·sin φ

A distance (gap) between the TFT substrate 20 and the CF substrate 21 is denoted by d, and a distance (shift amount) by which the black matrix BM is shifted with respect to the center of each of the switching transistors 23 is denoted by Δ. That is, the shift amount Δ is a distance between the center of each of the switching transistors 23 and the center of a portion of the black matrix BM which is intended to shield the switching transistor 23. The shift amount Δ is expressed by:

$$Δ = d \cdot tan φ = d \cdot \frac{sin θ}{\sqrt{{n}^{2} - {sin}^{2} θ}}$$

As indicated by the above expression, the shift amount Δ varies depending on the distance d and the tilt angle θ. FIG. 7 is an example of the shift amount Δ for the black matrix BM. In the example, the distance d=4 μm, and the refractive index n=1.5.

When the tilt angle θ=0, the shift amount Δ=0. This also applies to the configuration in the comparative example in FIG. 3. The shift amount Δ increases consistently with the tilt angle θ.

### Effects

As described above in detail, in the first embodiment, the head-up display 10 includes the liquid-crystal display apparatus 11, the light source 12, and the reflection member 13, and the liquid-crystal display apparatus 11 is arranged such that the perpendicular of the display surface of the liquid-crystal display apparatus is inclined at the predetermined tilt angle θ to the optical path of the light source 12. The liquid-crystal display apparatus 11 includes the black matrix BM formed on the CF substrate 21 which the illumination light from the light source 12 enters. With the tilt angle θ taken into account, the black matrix BM is arranged offset so as to achieve the optimum light shielding.

Therefore, in the first embodiment, the switching transistors 23 can be optimally shielded from light, allowing the off characteristics of the switching transistors 23 to be restrained from being degraded.

Furthermore, the apertures (display areas) of the pixels are not substantially shielded from light by the black matrix BM, and thus, the transmittance of light transmitted by the liquid-crystal display apparatus 11 can be restrained from being reduced.

### Second Embodiment

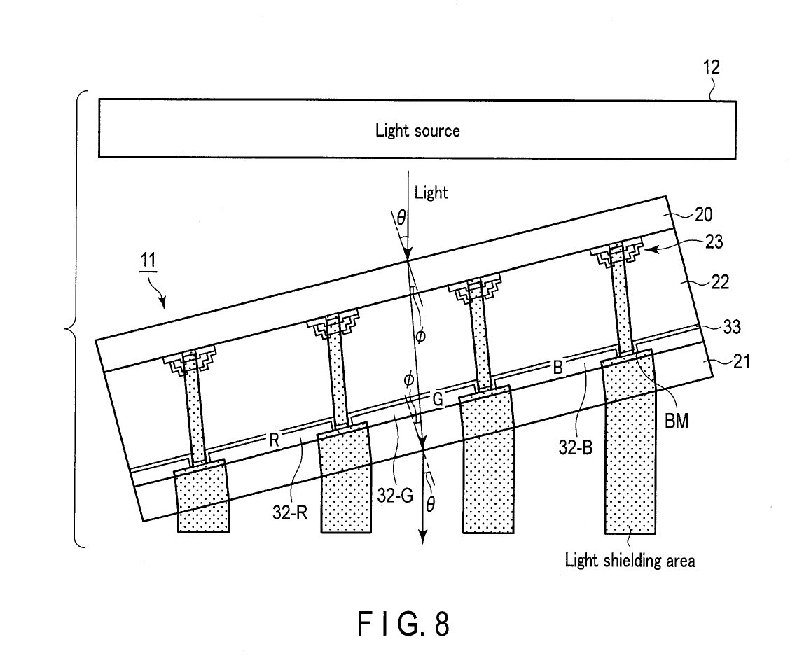

FIG. 8 is a schematic diagram of a liquid-crystal display apparatus 11 according to a second embodiment. A TFT substrate 20 on which switching transistors 23 (TFT) are formed is arranged opposite to a light source 12. That is, the liquid-crystal display apparatus 11 in the second embodiment results from rotation of the liquid-crystal display apparatus in the first embodiment through 180°. A lamination structure in the liquid-crystal display apparatus 11 in the second embodiment is the same as the lamination structure in the liquid-crystal display apparatus in the first embodiment.

A gate electrode 24 included in each of the switching transistors 23 is formed of a light shielding material. For example, chromium or aluminum is used as the light shielding material. A light shielding area defined by the gate electrode 24 extends through a semiconductor layer (amorphous silicon) 26 included in the switching transistor 23 and formed immediately above the gate electrode 24. Consequently, the semiconductor layer 26 is partly shielded from light, allowing the off characteristic of the switching transistor 23 to be restrained from being degraded.

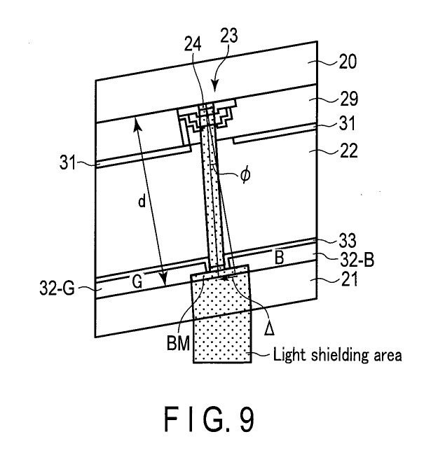

FIG. 9 is an enlarged diagram of a part of light shielding areas defined by the gate electrodes 24 and a black matrix BM in FIG. 8. The black matrix BM provided on a CF substrate 21 is arranged to be shifted (arranged offset) in the lateral direction such that light shielding areas defined by the gate electrode 24 extend through the black matrix BM. Consequently, the apertures (display areas) of pixels are not substantially shielded from light by the black matrix BM, and thus, a possible reduction in transmittance can be suppressed.

A distance (shift amount) Δ by which the black matrix BM is shifted with respect to the center of each of the switching transistors 23 is expressed using the same expression as that used in the first embodiment.

In the second embodiment described above in detail, the liquid-crystal display apparatus 11 is arranged with respect to the light source 12 such that the positional relation between the black matrix BM and the switching transistors 23 in the second embodiment is opposite to the positional relation between the black matrix BM and the switching transistors 23 in the first embodiment. Even when the head-up display 10 including the liquid-crystal display apparatus 11 is thus configured, the areas shielded from light by the gate electrodes 24 included in the switching transistors 23 extend through the black matrix BM. This enables suppression of a reduction in the transmittance for light transmitted by the liquid-crystal display apparatus 11. Furthermore, the areas shielded from light by the gate electrodes 24 extend through the corresponding semiconductor layers 26. Consequently, a part of each of the semiconductor layers 26 is shielded from light, allowing the off characteristic of the corresponding switching transistor 23 to be restrained from being degraded.

The present invention is not limited to the embodiments described above, and can be embodied by modifying constituent elements without departing from the gist of the invention. In addition, the above embodiments include inventions of various stages, and various inventions can be formed by proper combinations of a plurality of constituent elements disclosed in one embodiment or proper combinations of constituent elements disclosed in different embodiments. When, for example, the problems to be solved by the present invention can be solved and the effects of the invention can be obtained even if several constituent elements are omitted from all the constituent elements disclosed in each embodiment, an embodiment from which these constituent elements are omitted can be extracted as an invention.

What is claimed is:

1. A liquid-crystal display apparatus in which a perpendicular of a display surface of the liquid-crystal display apparatus is inclined through a tilt angle to an optical path of a light source, comprising:
a first substrate arranged opposite to the light source;
a second substrate arranged opposite to the first substrate;
a liquid-crystal layer sandwiched between the first substrate and the second substrate;
a color filter provided on the first substrate and having coloring members provided in association with pixels;
a black matrix provided on the first substrate and between adjacent coloring members; and
switching transistors provided on the second substrate in association with the pixels,
wherein the following expression is satisfied:
$$Δ = d \cdot \frac{sin θ}{\sqrt{{n}^{2} - {sin}^{2} θ}}$$
where the tilt angle is denoted by θ, a distance between the first substrate and the second substrate is denoted by d, a refractive index of each of the first and second substrates is denoted by n, and a shift amount by which the black matrix is shifted with respect to a center of a switching transistor is denoted by Δ.

2. The liquid-crystal display apparatus according to claim 1, wherein a portion of the black matrix corresponding to each of the switching transistors has a width equal to or larger than a width of the switching transistor.

3. A liquid-crystal display apparatus in which a perpendicular of a display surface of the liquid-crystal display apparatus is inclined through a tilt angle to an optical path of a light source, comprising:
a first substrate arranged opposite to the light source;
a second substrate arranged opposite to the first substrate;
a liquid-crystal layer sandwiched between the first substrate and the second substrate;
switching transistors provided on the first substrate in association with pixels;
a color filter provided on the second substrate and having coloring members provided in association with the pixels; and
a black matrix provided on the second substrate and between adjacent coloring members,
wherein the following expression is satisfied:
$$Δ = d \cdot \frac{sin θ}{\sqrt{{n}^{2} - {sin}^{2} θ}}$$
where the tilt angle is denoted by θ, a distance between the first substrate and the second substrate is denoted by d, a refractive index of each of the first and second substrates is denoted by n, and a shift amount by which the black matrix is shifted with respect to a center of a switching transistor is denoted by Δ.

4. The liquid-crystal display apparatus according to claim 3, wherein
each of the switching transistors includes a gate electrode, and
the gate electrode is formed of a light shielding material.

5. A head-up display comprising:
a light source;
the liquid-crystal display apparatus according to claim 1, the liquid-crystal display apparatus transmitting light from the light source; and
a reflection member which reflects display light from the liquid-crystal display apparatus toward a screen.
